(19) United States
(12) Patent Application Publication
(10) Pub. No.: US 2008/0008091 A1
(43) Pub. Date: Jan. 10, 2008

(54) Qos CONTROL SYSTEM

(76) Inventors: Kazuma Yumoto, Fuchu (JP); Akihiko Takase, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/764,400

(22) Filed: Jun. 18, 2007

(30) Foreign Application Priority Data
Jul. 10, 2006 (JP) 2006-189182

(51) Int. Cl. H04L 12/56

(52) U.S. Cl. 370/230; 370/252; 370/465

(57) ABSTRACT

A QoS control system for controlling allocation of a resource in a network, comprising: a terminal unit; a node unit for transferring a packet which is sent and to be received by the terminal unit; a resource requesting unit for requesting to allocate of a resource of the node unit; and a QoS control unit for controlling allocation of a resource of the node unit; in which the QoS control unit manages communication path information for transferring the packet received by the node unit, and resource information of the node unit, determines whether or not a node unit included in the communication path through which the terminal unit makes a communication can provide with a requested resource, and determines an alternative proposal of the requested resource when the node unit cannot provide with the requested resource, and notifies the resource requesting unit of the alternative proposal.

### CLAIM OF PRIORITY

The present application claims priority from Japanese patent application JP 2006-189 filed on Jul. 10, 2006, the content of which is hereby incorporated by reference into this application.

### BACKGROUND OF THE INVENTION

This invention relates to a QoS control system, more particularly to a technique for presenting an alternative proposal when it is impossible to supply a requested resource or quality.

In recent years, along with the expansion of the Internet utilization in various fields, multimedia services for distributing audio and video data are also expanding. However, in the case of transmission of conversational voices with use of VoIP, etc., it is required to suppress the delay of the network as much as possible. Otherwise, the voice quality is degraded significantly and the voice transmission is still considered to be low in real time property.

In such a situation, JP 2000-224239 A discloses a technique of a band management unit (QoS control unit) for allocating a communication band by controlling the band according to a service to be supplied, thereby keeping the network transmission quality. On the other hand, JP 2003-258857 A discloses a network policy control system. In this system, a call agent (call control unit) requests a policy server for a resource to be used for a communication between terminals when a session is established therebetween and the call agent, if there is a communication path that satisfies a requested resource amount, transmits data to the communication path.

Furthermore, RFC3312 “Integration of Resource Management and SIP”, IETF, October, 2002 discloses expanded specifications of a session control protocol that uses the SIP (Session Initiation Protocol) to make negotiation that includes QoS prior conditions. 3GPP Specification “TS29.209 Version 6.5.0”, 3GPP, Jun. 21, 2006 discloses specifications of a resource requesting interface used between a session control unit (call control unit) and such a unit as a QoS control unit, which has policy applying functions.

### SUMMARY OF THE INVENTION

In a conventional QoS control system, the QoS control unit can return a result of success (YES) or failure (NO) as a response to a QoS (resource and/or quality) request, but cannot present any resource which can be provided with and quality as alternative proposal.

Under such circumstances, it is an object of this invention to solve the above conventional problems and present alternative proposal which can be provided with when it is impossible to supply a requested resource and its quality.

A representative aspect of this invention is as follows. That is, there is provided a QoS control system for controlling allocation of a resource in a network, comprising: a terminal unit; a node unit for transferring a packet which is sent and to be received by the terminal unit; a resource requesting unit for requesting to allocate of a resource of the node unit; and a QoS control unit for controlling allocation of a resource of the node unit; in which the QoS control unit manages communication path information for transferring the packet received by the node unit, and resource information of the node unit; in which the QoS control unit determines whether or not a node unit included in the communication path through which the terminal unit makes a communication can provide with a resource requested from the resource requesting unit; and in which the QoS control unit determines an alternative proposal of the requested resource when the node unit cannot provide with the requested resource, and notifies the resource requesting unit of the alternative proposal.

According to one aspect of the present invention, the QoS control system can present alternative proposal which can be provided with if it is impossible to supply a requested resource and its quality.

### BRIEF DESCRIPTION OF THE DRAWINGS

The present invention can be appreciated by the description which follows in conjunction with the following figures, wherein:

FIG. 1 is a block diagram showing a configuration of a QoS control system in accordance with an embodiment of this invention;

FIG. 2 is a block diagram showing an access network which is applied the QoS control system in accordance with the embodiment of this invention;

FIG. 3 is a block diagram showing a configuration of a QoS control unit in accordance with the embodiment of this invention;

FIG. 4 is a block diagram showing a configuration of a session control unit in accordance with the embodiment of this invention;

FIG. 5 is a block diagram showing a configuration of a node information management table in accordance with the embodiment of this invention;

FIG. 6A is an explanatory diagram showing a configuration of a node use information management table in accordance with the embodiment of this invention;

FIG. 6B is a diagram showing a low latency queue and a weighted fair queue used by a shaper function of a node unit in accordance with the embodiment of this invention;

FIG. 6C is an explanatory diagram showing a configuration of a node use information management table in accordance with the embodiment of this invention;

FIG. 7 is an explanatory diagram showing a configuration of a request acceptance determination table in accordance with the embodiment of this invention;

FIG. 8 is an explanatory diagram showing a configuration of a resource allocation management table in accordance with the embodiment of this invention;

FIG. 9 is an explanatory diagram a configuration of a media mapping table in accordance with the embodiment of this invention;

FIG. 10 is a flowchart showing a processings executed by the QoS control unit in accordance with the embodiment of this invention;

FIG. 11 is a flowchart showing a QoS requesting processings executed by the session control unit in accordance with the embodiment of this invention;

FIG. 12 is a sequence diagram showing a processings for presenting a proposal of an alternative proposal to a QoS request by the QoS control unit in a core network in accordance with the embodiment of this invention;

FIG. 13 is a sequence diagram showing a processings for presenting a proposal of an alternative proposal to a QoS request by the QoS control unit in a source side access network in accordance with the embodiment of this invention;

FIG. 14 is a sequence diagram showing a processings for presenting a proposal of an alternative proposal to a QoS request by a QoS control unit of the destination side network in accordance with the embodiment of this invention;

FIG. 15 shows an example of an dialog for notifying the proposal of an alternative proposal to a user equipment in accordance with the embodiment of this invention; and

FIG. 16 shows an example of a screen for presetting a proposal of an alternative proposal in accordance with the embodiment of this invention.

### DETAILED DESCRIPTION OF THE PREFERRED EMBODIMENTS

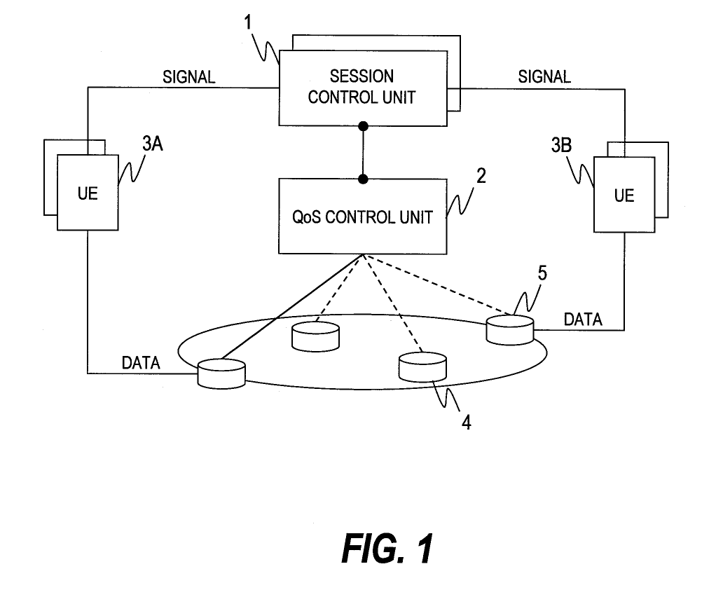

FIG. 1 shows a configuration of a QoS control system in accordance with an embodiment of this invention. The QoS control system comprises a session control unit 1, a QoS control unit 2, user equipments (UEs) 3A and 3B, a core node 4, and an edge node 5. The session control unit 1, the QoS control unit 2, and the user equipments 3A and 3B are connected to a network including the edge node 5 and the core node 4.

In FIG. 1, the session control unit 1, the QoS control unit 2, and the user equipments 3A and 3B are denoted separately to clarify the layered structure of the network and the flow of the signal and data packets. Therefore, the user equipments 3A and 3B are not connected directly to the session control unit 1 to send/receive signal packets to/from each other; those packets are sent/received between them through a network. Similarly, the session control unit 1 and the QoS control unit 2 are connected to each other through the network and the QoS control unit 2 is connected to the core node 4 and the edge node 5 through the network, respectively.

The session control unit 1 controls transfer of session control messages (call control messages) sent/received to/from the user equipments 3A and 3B through the network. The session control unit 1 also issues a QoS request to the QoS control unit 2 when a QoS prior condition is included in a session connection request received from the user equipment 3A or 3B.

In the QoS request, for example, the following parameters are set; session ID, flow direction (two way/sending direction/receiving direction), destination IP address/source IP address, protocol No., TCP/UDP destination/source port No., medium type, codec type, max request band width, priority level, request transfer quality (e.g., class regulated by ITU-T Recommendation Y.1541), etc.

The QoS control unit 2 determines weather or not it is possible to accept an object request upon its receiving. Upon the accepting, the QoS control unit 2 controls the QoS with respect to the node assumed as the subject flow path. The QoS control means reservation of a requested resource or quality. On the other hand, if it is impossible to supply the requested quality and if there is such a proposal, the QoS control unit 2 presents an alternative proposal. If there is not such a proposal, QoS control unit 2 returns the effect to the session control unit 1.

Receiving the response from the QoS control unit 2, the session control unit 1 determines the corresponding medium information according to the alternative proposal resource information and transfers the response to the user equipment 3.

A unit that is equivalent to the user equipment may be an application server. The unit that issues such a QoS request to the QoS control unit 2 may be an application server; it may not be the session control unit 1.

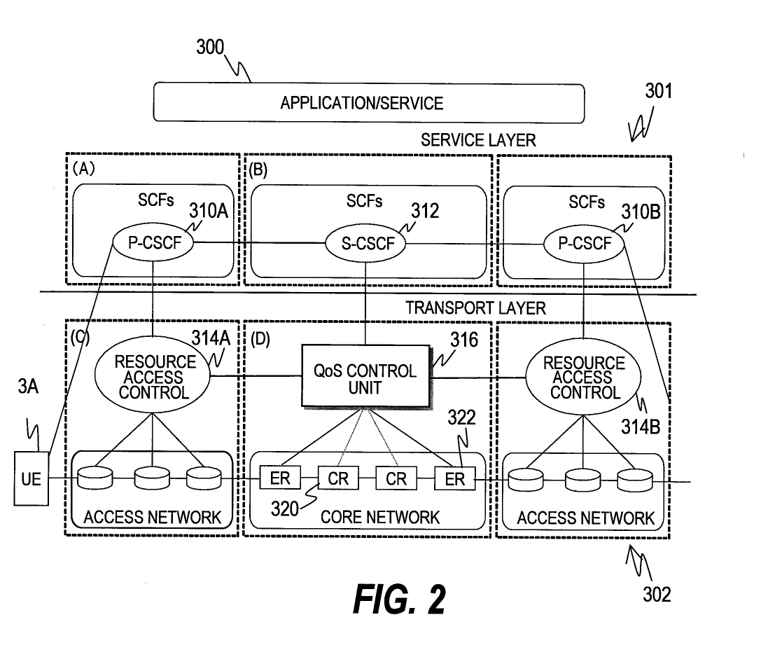

FIG. 2 shows an example of the QoS control system applied to an access network and a core network in accordance with this embodiment of this invention and a core network that clarifies a boundary between a transport layer 302 and a service layer 301.

The user equipment 3A is connected to the core network through the access network and the opposite user equipment through the another access network, respectively. Each of the access network and the core network is divided into the service layer 301 and the transport layer 302.

The session control unit 1 shown in FIG. 1 is equivalent to each of the P-CSCF (Proxy-Call Session Control Functions) 310A and 310B of the access network and the S-CSCF (Serving-CSCF) 312 of the core network. While the SCCF is included in the core network in FIG. 2, the provider of the SCFs (Service Control Functions) in (B) might differ from the provider of the core network in (D).

The core router 320 and the edge router 322 included in the core network are equivalent to the core node 4 and the edge node 5 shown in FIG. 1, respectively. The resource access control units 314A and 314B for controlling resources of the access network and the QoS control unit 316 are equivalent to the QoS control unit 2 shown in FIG. 1, respectively.

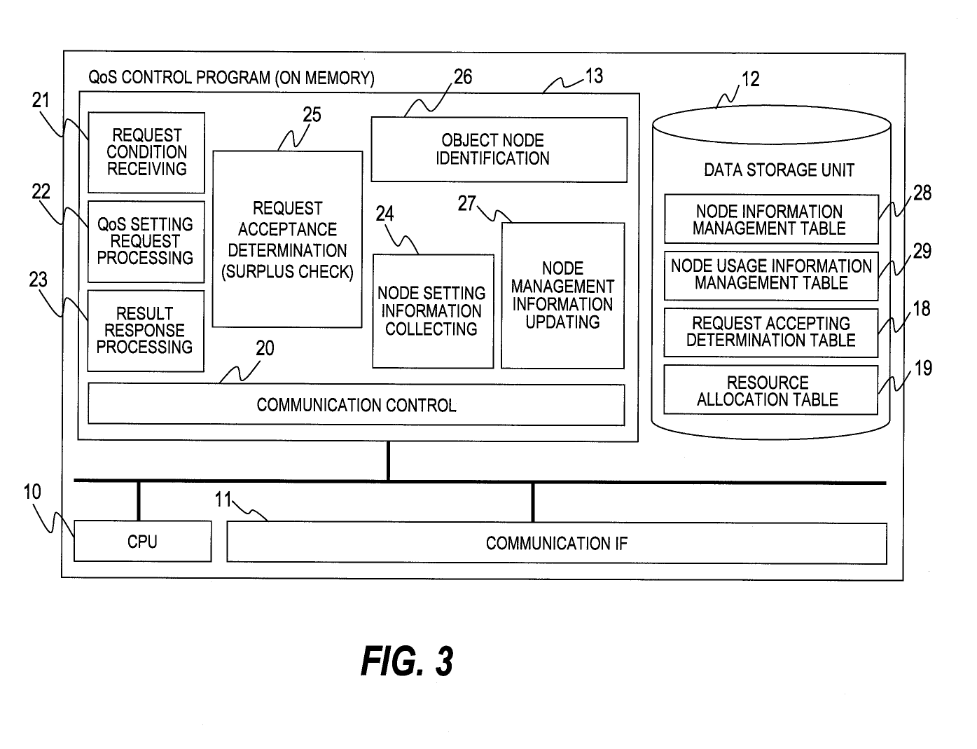

FIG. 3 shows a configuration of the QoS control unit 2 in accordance with this embodiment of this invention. The QoS control unit 2 comprises a CPU 10, a memory 13, a storage unit 12, and a communication interface (communication IF) 11.

The CPU 10 executes programs stored in the memory 13. The memory 13 stores programs executed by the CPU 10 and data required for the processings of the CPU 10. The communication IF 11 communicates with another computer through a network.

The storage unit 12 stores a QoS control program and data required for QoS controlling. The QoS control program is loaded into the memory 13 when it is executed. The storage unit 12 may be provided in the cabinet of the QoS control unit 2 or may be connected to the QoS control unit 2 through the network.

The QoS control unit 2 may also have a user interface through which the administrator can operate the unit 2. For example, the user interface may be any of a command input keyboard, a GUI input mouse, a display unit, or the like.

The QoS control program is composed of a communication control program 20, a request condition receiving program 21, a QoS setting request processing program 22, a result response processing program 23, a node setting information collecting program 24, a request acceptance determination program 25, a target node identification program 26, a node management information updating program 27, etc. Each of those programs may be independent programs each other which are executed respectively in a different process, or those programs may be integrated into a single program which is executed in the same process.

The communication control program 20 analyzes each packet received through the communication IF 11. The communication control program 20 also shapes and sends the header information of each packet to an object unit.

The request condition receiving program 21 analyzes the contents of each received QoS request. The QoS setting request processing program 22 sets the QoS for each object node. The result response processing program 23 returns a determination result to the request source with respect to each received QoS request.

The node setting information collecting program 24 collects node setting information included in an object network. The request acceptance determination program 25 determines whether or not it is possible to accept each received QoS request. The object node identification program 26 identifies an object node to which the requested QoS is allowed. The node management information updating program 27 updates the utilization situation of each node.

The storage unit 12 includes a node information management table 28, a node use information management table 29, a request acceptance determination table 18, and a resource allocation management table 19 for storing necessary information to execute the QoS controlling, respectively. Each of those tables may be composed as a database to be accessed as needed while it is provided in the storage unit 12 or may be loaded into the memory 13 and used upon executing the QoS control program.

The node information management table 28 holds the configuration information of each node of the network. The node use information management table 29 holds the utilization situation of each node of the network. The request acceptance determination table 18 holds the information used to determine whether or not it is possible to accept the whole of each QoS request according to a result of determination for whether or not it is possible to accept the subject QoS request in each of the outgoing side edge node and the incoming side edge node. The resource allocation management table 19 manages each resource allocated to each session.

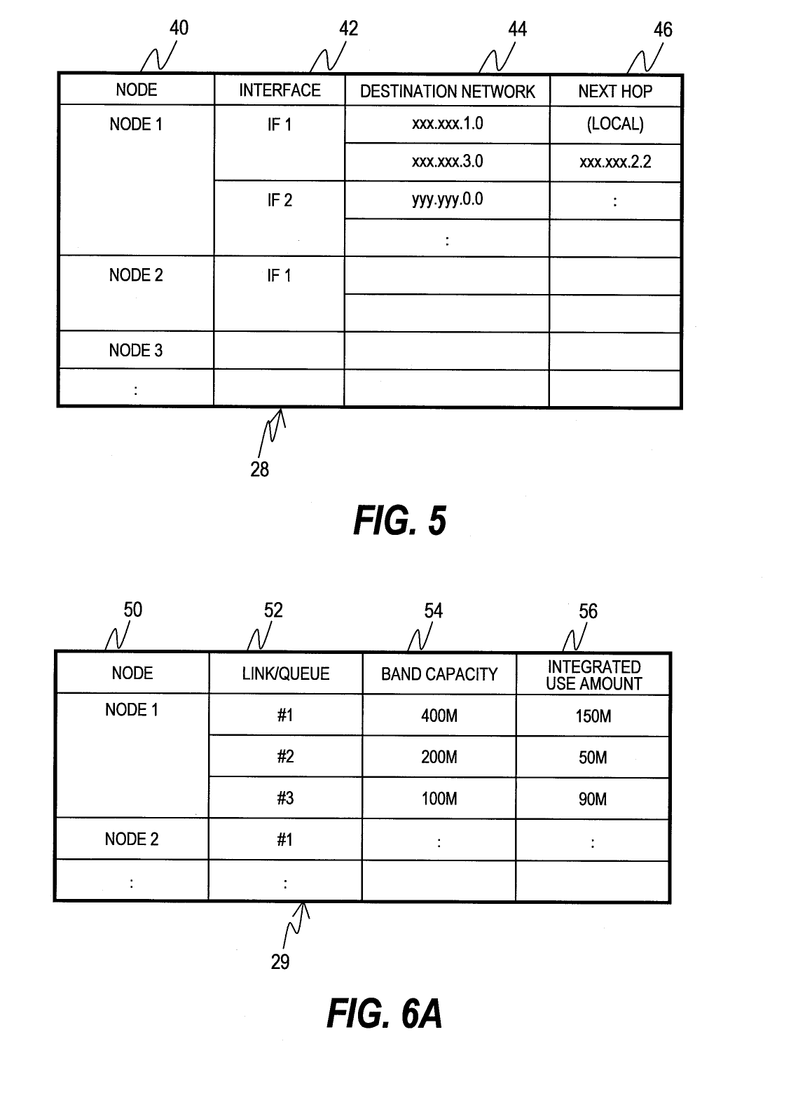

FIG. 5 shows a configuration of the node information management table 28 in accordance with this embodiment of this invention. The node information management table 28 records a result of each execution of the node setting information collecting program 24 by the QoS control unit 2 to collect each pieces of node routing information.

The node information management table 28 includes fields of node 40, interface 42, destination network 44, and next hop 46. The node field 40 holds the ID of each node of the subject network. In particular, the node field 40 holds the ID of the core node 4 or edge node 5 shown in FIG. 1. The interface field 42 holds the ID of each node communication IF. The next hop field 46 holds a router IP address of a destination network 44, to which a packet is to be transferred.

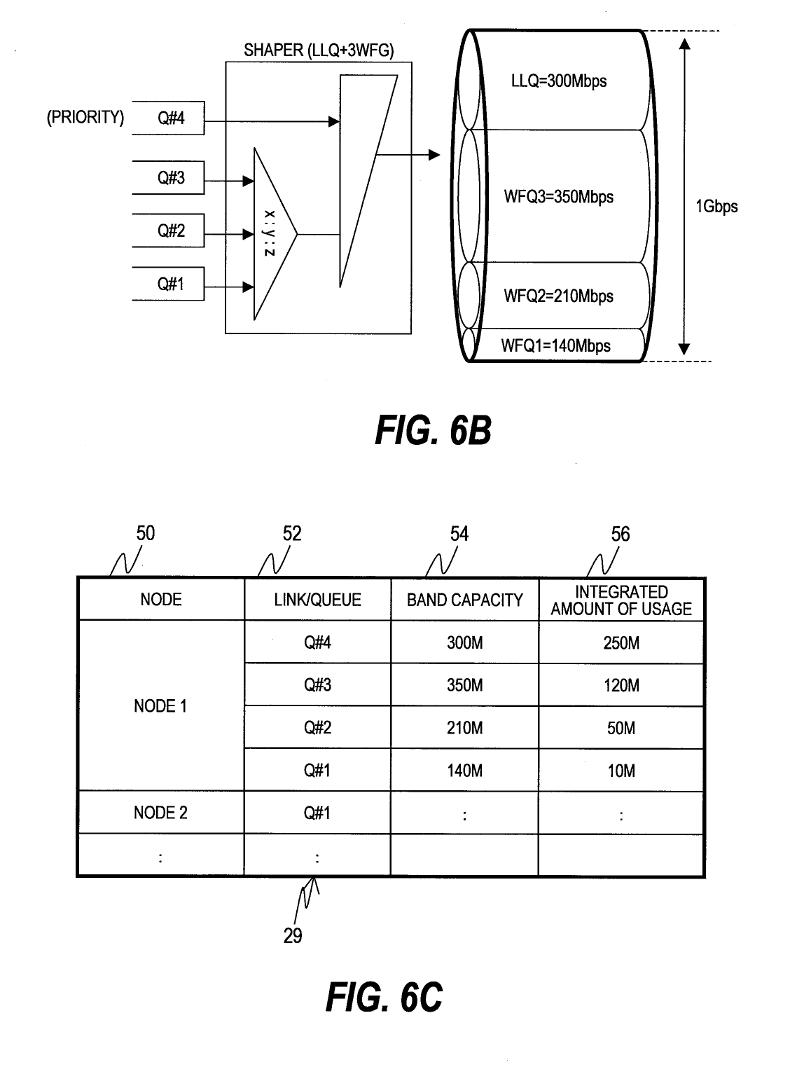

FIG. 6A shows a configuration of the node use information management table 29 for managing the use information of each link in accordance with this embodiment of this invention. The node use information management table 29 includes fields of node 50, link/queue 52, band capacity 54, and integrated amount of usage 56. The node use information management table 29 is updated each time the node management information updating program 27 is executed.

The node field 50 holds the ID of each node of the network. In particular, the node field 50 holds the ID of the core node 4 or edge node 5 shown in FIG. 1. The link/queue field 52 holds the ID of each node link or queue. In FIG. 6A, each link ID is held in the field 52. The band capacity field 54 holds a capacity of a band allocated to each link/queue. The integrated amount of usage field 56 holds a capacity of a band currently in use.

FIG. 6B shows a diagram for describing how a low latency queue and a weighted fair queue is used by a shaper function of a node unit in accordance with this embodiment of this invention. The shaper function controls an output order and an output band of each packet.

The shaper shown in FIG. 6B includes one low latency queue (LLQ) and three weighted fair queues (WFQs). The node unit controls the quality by transferring packets to the LLQ if it is necessary to transfer those packets preferentially even when they are in the same flow addressed to the same destination and transfer packets to one of the three WFQs if those packets may be transferred in the best effort mode just like the Internet communication.

In FIG. 6B, the Q#4 is an LLQ and outputs packets preferentially over the Q#1 to Q#3. On the bother hand, each of the Q#1 to Q#3 outputs packets according to the weight (X:Y:Z) for which a band not used by the LLQ is specified. In the case of the line shown in FIG. 6B, a total of 1 Gbps bands are allocated and a 300 Mbps band is allocated to the LLQ #4 and the rest bands are allocated to the WFQs #1 to #3 at a ratio of 5:3:2.

FIG. 6C shows a configuration of the node use information management table 29 for managing the use information of each queue in accordance with this embodiment of this invention. The table configuration is the same as that shown in FIG. 6A. The node use information management table 29 shown in FIG. 6C corresponds to the shaper function shown in FIG. 6B. The link/queue field 52 shown in FIG. 6C holds the ID of each queue.

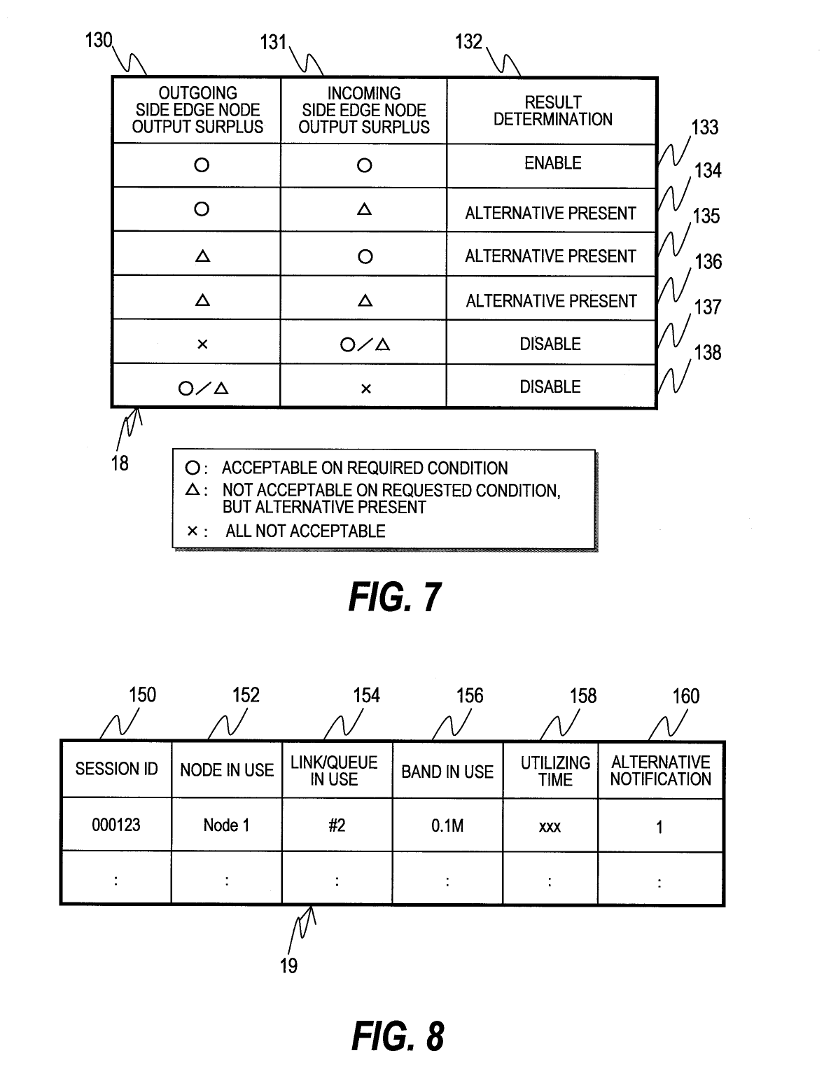

FIG. 7 shows a configuration of the request acceptance determination table 18 in accordance with this embodiment of this invention. The QoS control unit 2 determines a result of each QoS request by referring to the request acceptance determination table 18. In case where the network band capacity is allocated enough to determine a result of a QoS request, it is just required for the QoS control unit 2 to determine only the edge nodes at both incoming and outgoing sides; it is no need to determine for all the nodes included in the communication path. In accordance with this embodiment of this invention, therefore, the determination is made only for the edge nodes at both incoming and outgoing sides.

The request acceptance determination table 18 includes fields of output surplus 130 of the outgoing side edge node, output surplus 131 of the incoming side edge node, and result determination 132. The output surplus field 130 holds “O” for a received and satisfied QoS request. “Δ” for existence of an alternative proposal, and “X” for not existence of any alternative proposal, respectively. This is also true for the output surplus field 131 of the incoming side edge node.

The result determination field 132 holds a result of each QoS request determined according to a relationship between the output surplus 130 of the outgoing side edge node and the output surplus 131 of the incoming side edge node. In particular, the result determination field 132 denotes “enable” when “O” is set in both values of the incoming side and outgoing side edge nodes (step 133) and “disable” when “X” is set in any of the values (steps 137 and 138). If it is possible to present an alternative proposal, the result determination field 132 denotes “alternative” (steps 134 to 136).

FIG. 8 shows a configuration of the resource allocation management table 19 in accordance with this embodiment of this invention. The resource allocation management table 19 holds each session record. The resource allocation management table 19 includes fields of session ID 150, node in use 152, link/queue 154, band in use 156, utilizing time 158, and alternative notification 160.

The session ID field 150 holds the ID of each session used by a user equipment. The node in use field 152 holds the ID of each node for which QoS controlling is executed. The link/queue field 154 holds the ID of each link or queue for which QoS controlling is executed. The band in use field 156 holds each band allocated through QoS controlling. The utilizing time field 158 may holds each use starting time and each utilizing time. The alternative notification field 160 sets a flag to prevent duplicated setting of an alternative proposal when an alternative proposal is already notified to the subject session.

Next, a description will be made for the processings to be executed by the QoS control unit 2 in the above configuration.

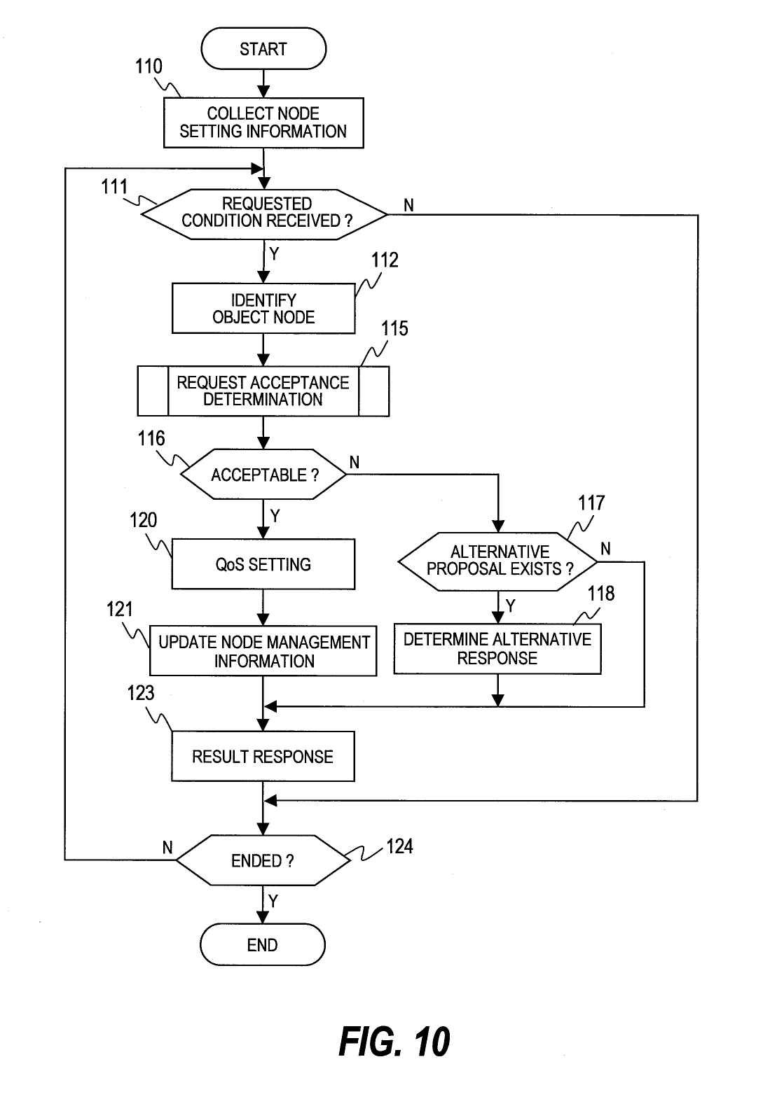

FIG. 10 shows a flowchart of the processings executed by the QoS control unit 2 in accordance with this embodiment of this invention.

The QoS control unit 2, when it is started up, collects setting information of an object node to be controlled with use of the node setting information collecting program 24 (step 110). The collected node setting information is held in the node information management table 28 shown in FIG. 5. In particular, the QoS control unit 2 collects the routing information set in each object node and records the destination network 44 and the next hop 46 for each interface 42 of the node 40.

In the flowchart shown in FIG. 10, the node setting information collecting program 24 is executed just after the QoS control unit 2 is started up. However, the program 24 may be executed for each periodical batch processing. The program 24 may also be executed upon updating the network topology, upon a trigger from the administrator or external unit, or upon a timing of QoS request issuing.

Upon the completion of the node setting information collection, the QoS control unit 2 accepts another QoS request from the application server 300 or the session control unit 1 (step 111). Receiving the QoS request (result in step 111 is “Y”), the QoS control unit 2 executes the request condition receiving program 21 to analyze the contents of the request. If no QoS request is received (result in step 111 is “N”), the QoS control unit 2 continues the QoS request receiving.

After that, the QoS control unit 2 executes the object node identification program 26 according to the request contents to identify the object node for which the QoS controlling is to be executed (step 112). In particular, the QoS control unit 2 refers to the node information management table 28 according to the destination address and the source address included in the QoS request and selects a communication path through which packets are to be sent and extracts the nodes and the communication IFs included in the path.

Furthermore, the QoS control unit 2 extracts a record in which a value held in the next hop field 46 is not included in the management domain, from the reference result, thereby the QoS control unit 2 can identify the object edge node. By identifying an edge node to be connected to the source address first in such a way, the QoS control unit 2 can identify the starting point in the object network. By using the topology information also at this time, the QoS control unit 2 can improve the efficiency for identifying such a node on an object communication path. As described above, in accordance with this embodiment, only the incoming side and outgoing side edge nodes of the object network are assumed as object nodes.

Upon identifying the object node for QoS controlling, the QoS control unit 2 executes the request acceptance determination program 25 to determine whether or not it is possible to accept the subject QoS request (step 115).

The QoS control unit 2 then extracts a record corresponding to the object node 50 and the object link/queue 52 from the node use information management table 29 to obtain the utilization situation of the object node. The QoS control unit 2 then determines whether or not it is possible to accept a QoS request from the object node according to the obtained utilization situation. In particular, the QoS control unit 2 compares the value obtained by adding a requested capacity to the integrated amount of usage 56 with the value held in the band capacity field 54 to determine whether or not it is possible to accept a QoS request from each object node. After that, the QoS control unit 2 refers to the request acceptance determination table 18 to determine whether or not it is possible to accept a QoS request according to the result of the determination for both incoming side and outgoing side edge nodes.

When the result of determination is “enable”, the QoS control unit 2 executes the QoS setting request processing program 22 to set the QoS for the object node (step 120).

Completing the QoS setting, the QoS control unit 2 executes the node management information updating program 27 to update the integrated amount of usage 56 in the node use information management table 29 (step 121). At this time, the QoS control unit 2 may update the node use information management table 29 after setting the QoS in such a way or update the object value by actually monitoring the traffic state of each node. The QoS control unit 2 may monitor the traffic state by itself in such a way or an external dedicated unit may monitor the traffic state.

On the other hand, when the result of determination for whether or not it is possible to accept a QoS request is “alternative”, the QoS control unit 2 determines an allocatable band (step 118). The allocatable band can also be obtained by extracting a record corresponding to the object node 50 and the object link/queue 52 from the node use information management table 29 and calculating a difference between the band capacity 54 and the integrated amount of usage 56.

If a priority level or request transfer quality condition is specified as a parameter in the QoS request, at first the QoS control unit 2 extracts a corresponding link/queue. At that time, if the requested condition cannot be satisfied, the QoS control unit 2 may extract the link/queue state corresponding to another priority level or requested transfer quality and notify the link/queue state as an alternative proposal. The QoS control unit 2 may also notify both priority and request transfer quality/allocatable band as alternative proposal. How to select such alternative proposal will be described in detail later.

Then, the QoS control unit 2 executes the result response processing program 23 according to the received QoS request to respond to the QoS request source (step 123). The QoS control unit 2 then determines whether to end the QoS request receiving (step 124). If the condition for ending the QoS request receiving is satisfied (result in step 124 is “Y”), the QoS control unit 2 exits the processing. If the ending condition is not satisfied (result in step 124 is “N”), the QoS control unit 2 waits for receiving another QoS request.

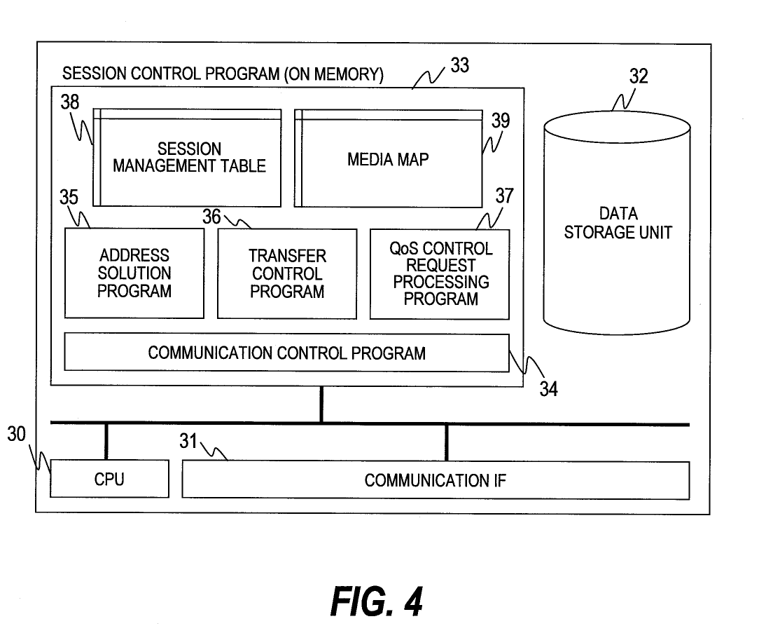

FIG. 4 shows a configuration of the session control unit 1 in accordance with this embodiment of this invention. The session control unit 1 includes a CPU 30, a memory 33, a storage unit 32, and a communication IF 31.

The CPU 30 executes programs stored in the memory 33. The memory 33 stores programs executed by the CPU 30 and data required for the processings of the CPU 30. The communication IF 31 communicates with another computer through a network.

The storage unit 32 stores a session control program and data required for managing sessions. The session control program is loaded into the memory 33 when it is executed. The storage unit 32 may be provided in the cabinet of the session control unit 1, provided as an external storage unit, or connected to the session control unit 1 through a network.

The session control unit 1 may also include a user interface for enabling the administrator to operate the session control unit 1. The user interface may be any of a command input keyboard, a GUI input mouse, a display unit, etc.

The session control program is composed of a communication control program 34, an address solution program 35, a transfer control program 36, a QoS control request processing program 37, etc. Each of those programs may be independent programs each other which are executed respectively in a different process, or those programs may be integrated into a single program which is executed in the same process.

The communication control program 34 analyzes each packet received through the communication IF 31. The communication control program 34 also shapes and sends the header information of each received packet to an object unit.

The address solution program 35 executes DNS searching, etc. to solve each IP address when the address information is described in such a domain format as FQDN (Fully Qualified Domain Name) or the like or the URL (Uniform Resource Locator) format.

The transfer control program 36 processes messages (packets) received by the communication control program 34 through the communication IF 31. The QoS control request processing program 37 sends QoS requests to the QoS control unit 2. The QoS control request processing program 37 also receives a response from the QoS control unit 2 with respect to each QoS request.

Each of the session management table 38 and the media mapping table 39 is stored in the memory in FIG. 4. However, they may also be loaded into the memory 33 when they are executed, respectively. They may also be composed as databases to be accessed as needed while they are stored in the storage unit 12, respectively.

The session management table 38 records the state transition information of each session. The media mapping table 39 holds a correspondence between medium information and each band.

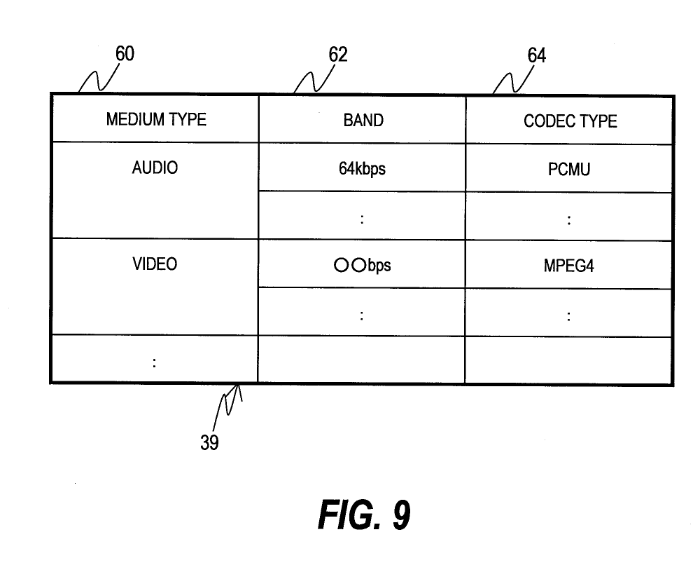

FIG. 9 shows a configuration of the media mapping table 39 in accordance with this embodiment of this invention. The session control unit 1 converts an alternative proposal presented by the QoS control unit 2 according to the media mapping table 39 and sends the result to the user equipment 3A or 3B.

The media mapping table 39 includes fields of medium type 60, band 62, and codec type 64. The medium type field 60 holds medium types. For example, the medium type field 60 holds such values as “Audio”, “Video”, etc. The band field 62 holds necessary band capacities and the codec type field 64 holds corresponding codec names.

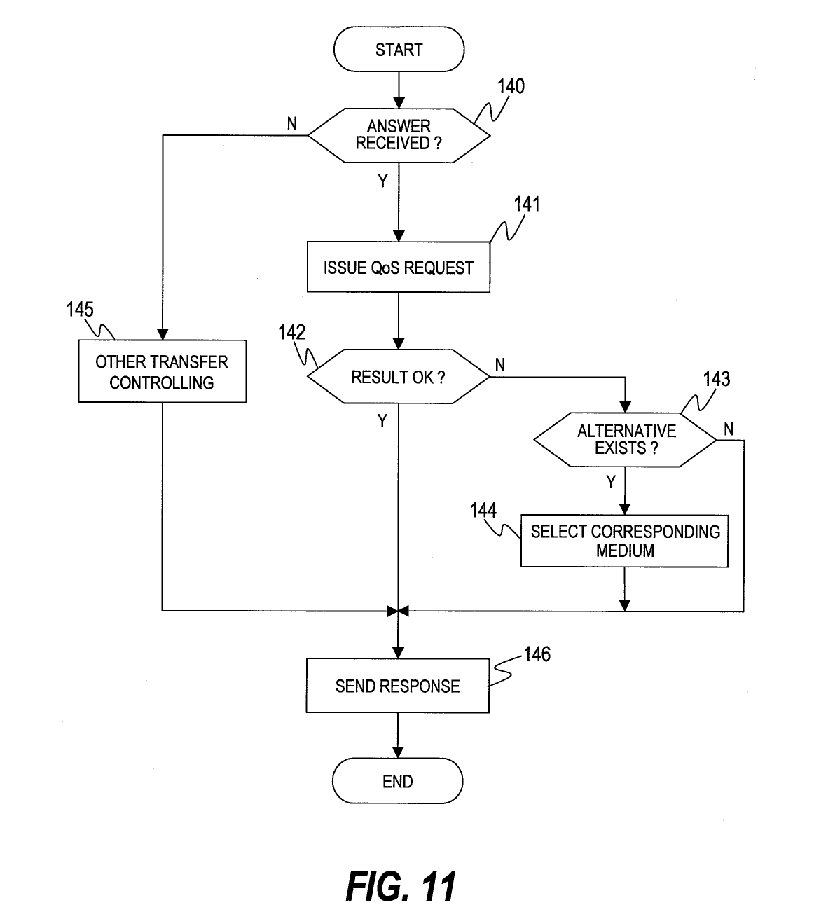

FIG. 11 shows a flowchart of the processings executed for an answer received by the session control unit 1 in accordance with this embodiment of this invention. The answer means a response message sent from a called side (opposite side) user equipment in response to a request offer sent from a calling side user equipment. In case where SIP is used as the session control protocol, a request offer is equivalent to an INVITE message.

Receiving a message, the session control unit 1 analyzes the received message with use of the transfer control program 36. The session control unit 1 then determines whether or not the received message is an answer including a QoS request (step 140). If the received message is not an answer (result in step 140 is “N”), the session control unit 1 executes such a processing as transferring as an ordinary session control unit (step 145).

If the received message is an answer (result in step 140 is “Y”), the session control unit 1 issues a QoS request to the QoS control unit 2 (step 141).

Receiving the QoS request, if the maximum requested band is specified as a parameter, the QoS control unit 2 executes a request acceptance determination processing 115 according to the specified maximum requested band (step 115 in FIG. 10). If the maximum requested band is not specified, the QoS control unit 2 is required to obtain a requested band. For example, if a medium type and a codec type are specified as parameters, the QoS control unit 2 may be provided with medium information that is equivalent to the media mapping table 39 so that the QoS control unit 2 can obtain the requested band according to the medium type and the codec type.

The medium information should preferably be provided outside the QoS control unit 2 to flexibly correspond to new media or new codec even when the maximum requested band is specified or even when a medium type and a codec type are specified. For example, the medium information may be provided in the session control unit 1 or in the application server.

The session control unit 1 receives a response message from the QoS control unit 2. If the result is “success” (result in step 142 is “Y”), the QoS control unit 2 transfers the received message as is (step 146).

If the result is “fail” (result in step 142 is “N”) and if an alternative proposal is presented (result in step 143 is “Y”), the session control unit 1 refers to the media mapping table 39 to select a corresponding medium type (step 144). In accordance with this embodiment of this invention, an alternative proposal is notified with a band, so that the session control unit 1 selects a codec to be fit in the band notified as an alternative proposal.

A response message to a calling side user equipment 3A is sent as an error response (e.g., response 580) (step 146) even when an alternative proposal is presented. At this time, the response message format is expanded to notify the information of the medium to be assumed as an alternative proposal.

If the result of the response message from the QoS control unit 2 is “N (fail)” (result in step 142 is “N”) and if no alternative proposal is presented (result in step 143 is “N”), the session control unit 1 transfers the received message as is (step 146).

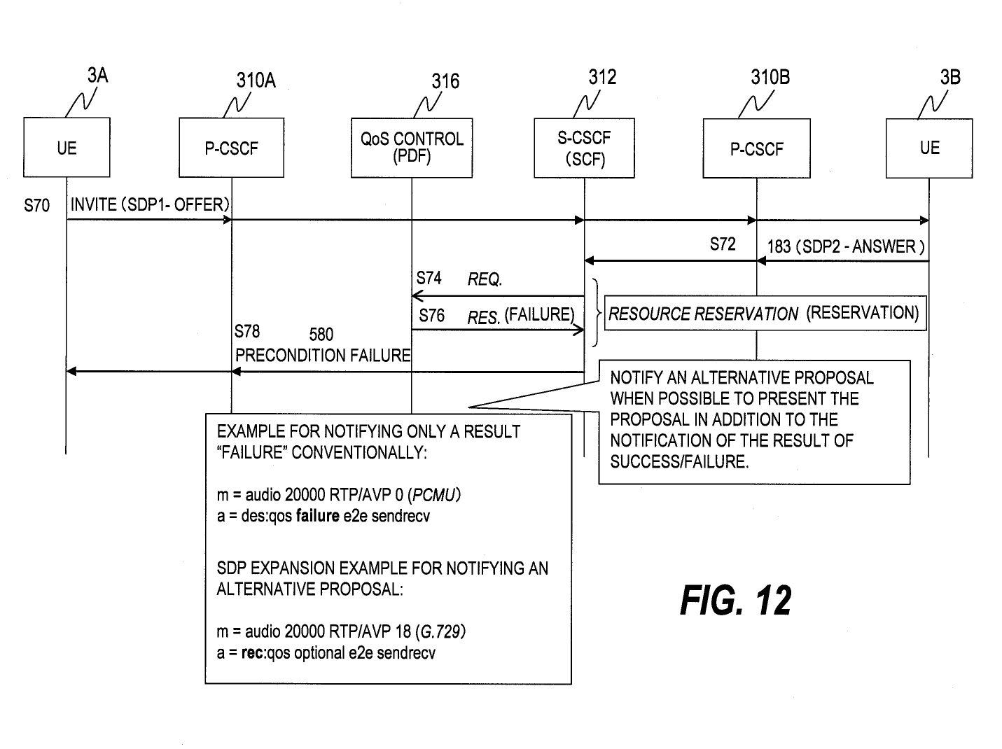

FIG. 12 shows a sequence of processings for presenting a proposal of an alternative proposal to a QoS request issued to the QoS control unit 2 of the core network in accordance with this embodiment of this invention. In FIG. 12, the QoS controlling for the access networks at both calling and called sides are omitted.

Also in accordance with this embodiment of this invention, the session control protocol SIP is used. Medium information is described with use of the SDP (Session Description Protocol).

At first, the user equipment 3A sends an INVITE message that includes medium information to the opposite user equipment 3B to start a communication (S70). The message is transferred to the P-CSCF310A and the S-CSCF312 of the calling side access network and the P-CSCF310B of the called side access network, respectively, thereby the message is received by the opposite user equipment 3B.

The opposite user equipment 3B sends an answer (S72) as a response to the INVITE message (S70). The answer is sent to the S-CSCF 312 through the P-CSCF 310B of the called side access network. The opposite user equipment 3B describes a communicable medium type in the answer. The medium type is included in the INVITE message (S70). Hereunder, the processings of the answer (S70) that includes a QoS request will be described.

Receiving an answer that includes a QoS request (result in step 140 is “Y”), the S-CSCF 312 issues a QoS request to the QoS control unit 316 (S74, step 141 in FIG. 11).

Receiving the QoS request (result in step 111 is “Y”), at first the QoS control unit 316 identifies an object node to which the QoS is applied (step 112 in FIG. 10). After that, the QoS control unit 316 determines whether or not it is possible to accept a resource and a band requested from the object node (step 115 in FIG. 10). In accordance with this embodiment of this invention, the QoS control unit 316 cannot accept a received QoS as is, but can present an alternative means (result in step 116 in FIG. 10 is “N” and result in step 117 is “Y”). As described above, the alternative proposal can be a capacity obtained by referring to the node use information management table 29 and calculating the difference between the object node band capacity and the integrated amount of usage 56.

Here, a description will be made for an example of how to select an alternative proposal concretely according to the data set in the node use information management table 29 for managing use information. When the node 1 and the #3 link are identified as an object node, the band capacity 54 is 100 MB and the integrated amount of usage 56 is 90 MB. If the requested band capacity is 15 MB, the difference between the band capacity 54 and the integrated amount of usage 56 is 10 MB. Thus the received QoS request cannot be accepted. An alternative proposal that assumes the usable band as 10 MB can be presented.

The QoS control unit 316 may also refer to the resource allocation management table 19 shown in FIG. 9 to allocate a resource after a specified time. At this time, the QoS control unit 2 extracts a record including a band in use 156 that satisfies the requested band from the resource allocation management table 19 according to the object node and the object link/queue. Then, the QoS control unit 316 calculates a “possible resource using time” according to the utilizing time 158 with respect to the session that is to be ended earliest and notifies the calculated using time. The QoS control unit 316 sets a flag in the alternative notification 160 to prevent duplicated notification. A record that has passed a use ending time is deleted periodically by a garbage collecting processing.

Next, a description will be made concretely for an example for selecting an alternative proposal according to the data in the node use information management table 29 for managing use information of each queue shown in FIG. 6C. If node 1 is identified as an object node and a 100 MB communication band is requested for assuring the quality (QoS, priority control/priority transfer), the Q#4 band capacity is 300 MB and the integrated amount of usage has already reached 250 MB. Consequently, the LLQ Q#4 cannot accept a new flow that requires a 100 MB band.

Thus the QoS control unit 316 can present an acceptable band under 50 MB as an alternative proposal. Then, the QoS control unit 316 may also refer to the resource allocation management table 19 to present a time on which the requested band (100 MB) can be supplied. According to the utilization situation of the WFQs (Q#3/Q#2/Q#1), the QoS control unit 316 determines whether or not a new 100 MB band can be supplied. If it can be provided and if the communication is a best effort type one, the QoS control unit 316 can denote that the 100 MB band can be supplied.

Although the bandwidth differs among Q#1 to Q#3, those are all WFQs. Thus the QoS control unit 316 can set a priority level in each of the queues Q#1 to Q#3; the unit 316 can also set a high priority level that differs among those queues.

Furthermore, the QoS control unit 316 can use Q#1 to Q#3 each in its proper way according to the object medium type. For example, if the QoS control unit 316 uses Q#3 for the best effort type video/audio communications, Q#2 for the best effort HTTP communications, and Q#1 for other best effort communications, the QoS control unit 316 presents an alternative proposal according to the utilization situation of the Q#3 when the QoS-requested object flow is video/voice communications.

The QoS control unit 316, upon determining an alternative proposal (step 118 in FIG. 10), notifies the S-CSCF 312 of the determined alternative proposal (S76, step 123 in FIG. 10).

The S-CSCF 312 receives the result of the determination of whether or not it is possible to accept a QoS request from the QoS control unit 316 (step 142 in FIG. 11). If it is impossible to accept a QoS request (result in step 142 in FIG. 11 is “N” and an alternative proposal is presented (result in step 143 in FIG. 11 is “Y”), the S-CSCF 312 selects a medium type corresponding to the alternative proposal (step 144 in FIG. 11). Because the alternative proposal is a band, the S-CSCF 312 refers to the media mapping table 39 and obtains a corresponding medium (codec type 64) that satisfies the presented band.

Obtaining the corresponding medium, the S-CSCF 312 notifies the user equipment 3A of the alternative proposal (S78, step 146 in FIG. 11). In accordance with this embodiment of this invention, the S-CSCF 312 uses the SDP format to notify the message and specifies the information of the medium assumed as the alternative proposal in the “m=” line. In particular, the S-CSCF 312 describes “m=audio 20000 RTP/AVP 18 (G.729)” in the “m=” line. Then, the S-CSCF 312 defines a new identifier (rec: recommendation) that denotes that the alternative proposal is recommended in the “a=” line and notifies the user equipment 3A of the presentation of the alternative proposal. In particular, the S-CSCF 312 is just required to describe “a=rec:qos optional e2e sendrecv” in the “a=” line.

On the other hand, if it is impossible to accept (result in step 142 in FIG. 11 is “N”) and if no proposal is presented (result in step 143 in FIG. 11 is “N”), the S-CSCF 312 notifies the user equipment 3A of the effect (S78, step 146 in FIG. 11). In particular, the S-CSCF 312 returns an error response message (e.g., response 580) at this time. The S-CSCF 312 is just required to use the conventional message format and specify an identifier “failure” in the “a=” line.

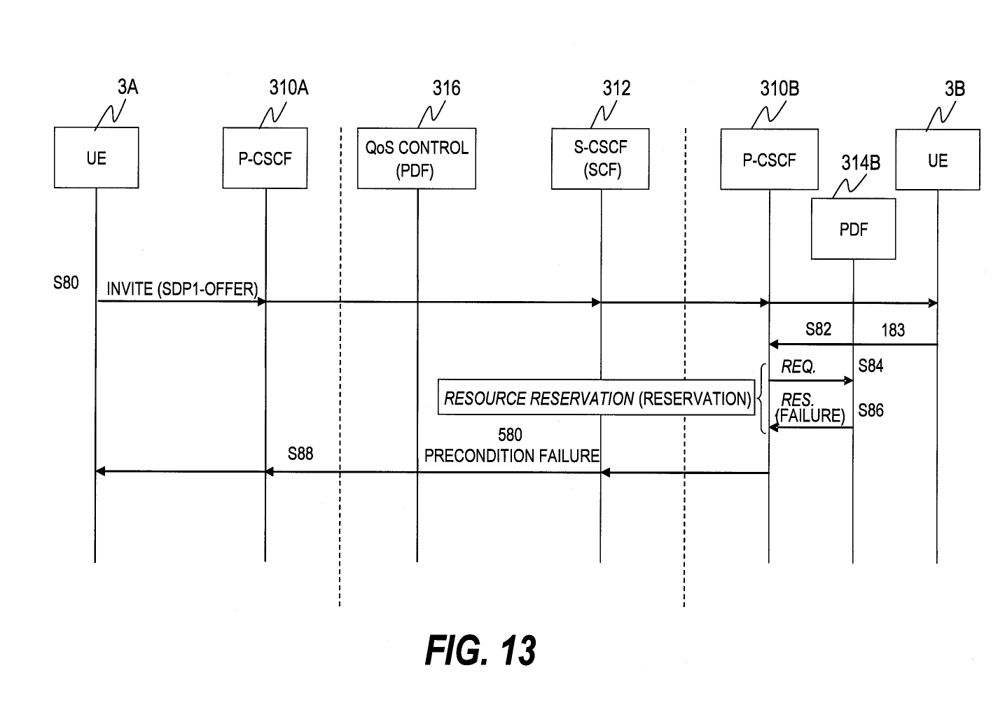

FIG. 13 shows a sequence of the processings for presenting a proposal of an alternative proposal from a QoS control unit of a source side access network in accordance with this embodiment of this invention. The called side access network includes a PDF (Policy Decision Function) 314B that is a QoS control unit.

As described above, the user equipment 3A sends an INVITE message (S80) to the opposite user equipment 3B and the opposite user equipment 3B sends back an answer (S82), thereby a communication is started between those equipments. This procedures are the same as S70 and S72 shown in FIG. 12.

The answer sent from the opposite user equipment 3B is transferred first to the P-CSCF 310B of the called side access network. Receiving the answer (result in step 140 in FIG. 11 is “Y”), the P-CSCF 310B issues a QoS request to the PDF 314B (S84, step 141 in FIG. 11). The procedures from the QoS request issuing (S84) to the result response receiving (S86) are the same as those from S74 to S76 shown in FIG. 12.

Then, if the content of the response message sent from the P-CSCF 310B (S88) is an error response, the S-CSCF 312 transfers the message without issuing a QoS request to the QoS control unit 316 regardless of whether an alternate proposal is presented or not. The P-CSCF 310A of the calling side access network also makes the similar processings. In other words, in step 140 in FIG. 11, if the P-CSCF 310A receives an error response as an answer, the P-CSCF 310A functions as a general session control unit and transfers the received message as is (step 145 in FIG. 11).

As described above, the PDF 314B has the similar functions as those of the QoS control unit 316. However, the sequence described above remains the same even when the PDF 314B has no function for presenting an alternative proposal and has only a function for determining whether or not it is possible to accept a QoS request. If the received message is an error response, the session control unit transfers the received message as is without issuing any QoS request.

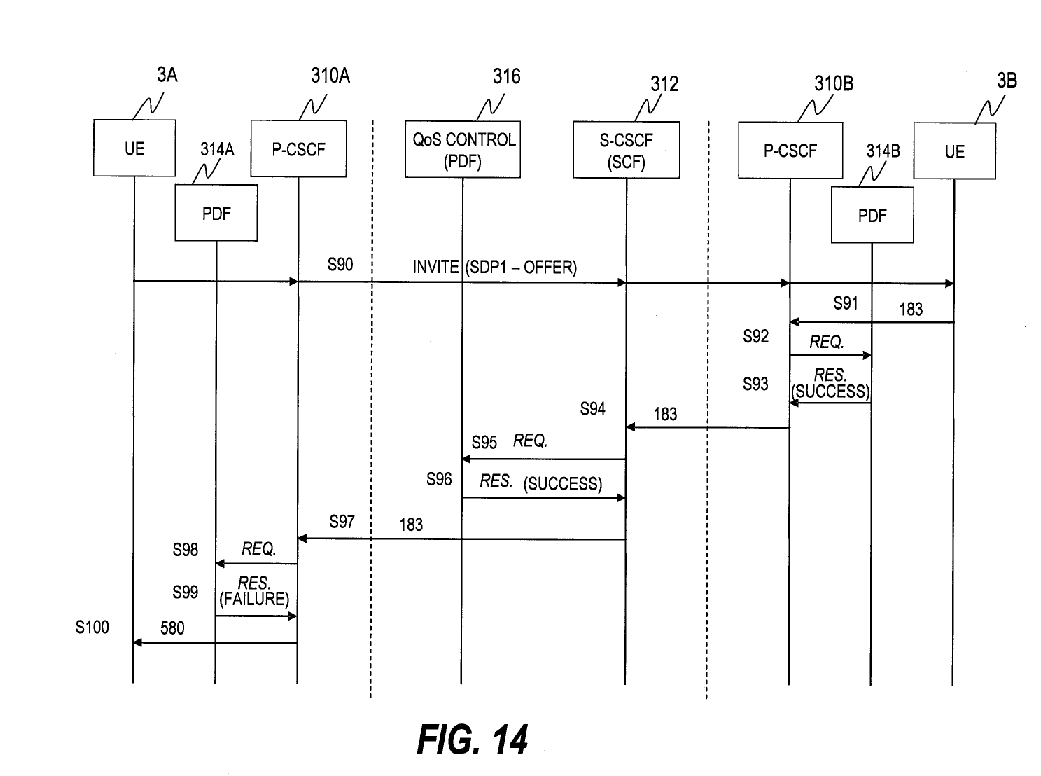

FIG. 14 shows a sequence of the processings for presenting an alternative proposal from a QoS control unit of the destination side network in accordance with this embodiment of this invention. The calling side access network includes a PDF 314A that is a QoS control unit. In FIG. 14, each of the called side access network, the core network, and the calling side access network determines whether or not it is possible to accept a QoS request.

Then, the user equipment 3A sends an INVITE message to the opposite user equipment 3B (S90) and the user equipment 3B returns an answer (S91), thereby a communication begins between those equipments. This procedures are the same as those S70 and S72 shown in FIG. 12.

Receiving the answer from the user equipment 3B (S91), the P-CSCF 310B sends a QoS request to the PDF 314B (S92). The P-CSCF 310B then receives a message denoting “possible to accept” from the PDF 314B (S93) and transfers the received message to the S-CSCF 312 (S94) as is.

Receiving the message from the P-CSCF 310B (S94), the S-CSCF 312 sends a QoS request to the QoS control unit 316 (S95). The S-CSCF 312 then receives a message denoting “possible to accept” from the QoS control unit 316 (S96) and transfers the received message to the P-CSCF 314A (S97).

Receiving the message from the S-CSCF 312 (S97), the P-CSCF 310A sends a QoS request to the QoS control unit 316 (S98). Thus the P-CSCF 310A receives a message “impossible to accept” from the QoS control unit 316 and transfers the received message to the user equipment 3A (S100).

In such a way, the PDF 314A executes QoS controlling to each object network to transfer an answer response in order to allocate the QoS between the calling side user equipment 3A and the called side user equipment 3B. The PDF 314A executes the QoS controlling when the content of the received message is not an error response. If the content is an error response, the PDF 314A does not execute the QoS controlling and functions as an ordinary session control unit to transfer the message.

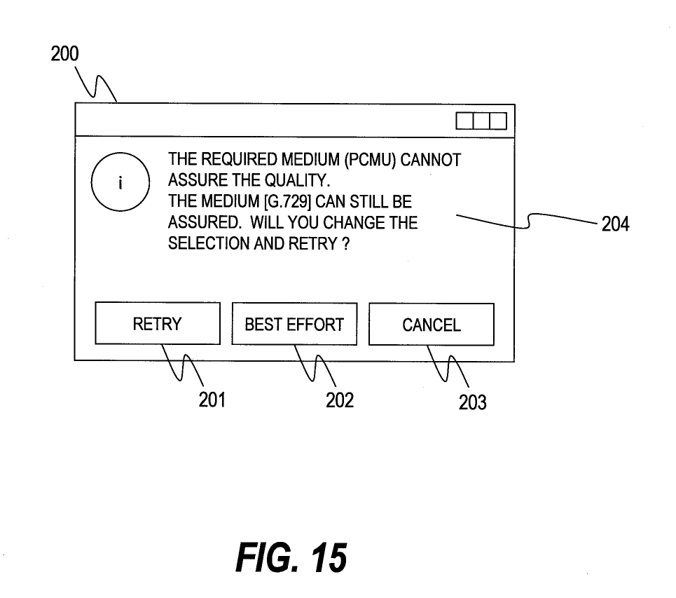

FIG. 15 shows an example of an equipment notification dialog displayed when a user equipment receives an answer response including an alternative proposal in accordance with this embodiment of this invention.

In particular, the user equipment 3A makes an attempt to connect the opposite user equipment 3B and displays a dialog 200 to notify the user of the alternative proposal when the proposal is presented.

The dialog 200 includes a notification field 204, a “Retry” button 201, a “Best Effort” button 202, and a “Cancel” button 203.

The notification field 204 denotes an alternative proposal of a communicable medium by notifying the user that a medium requested by the user cannot be used. In the dialog shown in FIG. 15, the medium requested by the user is “PCMU” and the presented alternative proposal is “G.729”. In the notification field 204, the description except for the medium information may be standardized and the medium information included in the response message may be embedded in the description.

Upon communicating with use of the notified alternative proposal, the user selects the “Retry” button 201 to re-connect the object equipment with use of the alternative proposal. Upon re-connecting the object equipment without executing QoS controlling, the user selects the “Best Effort” button 202. Upon canceling the connection, the user selects the “Cancel” button 203.

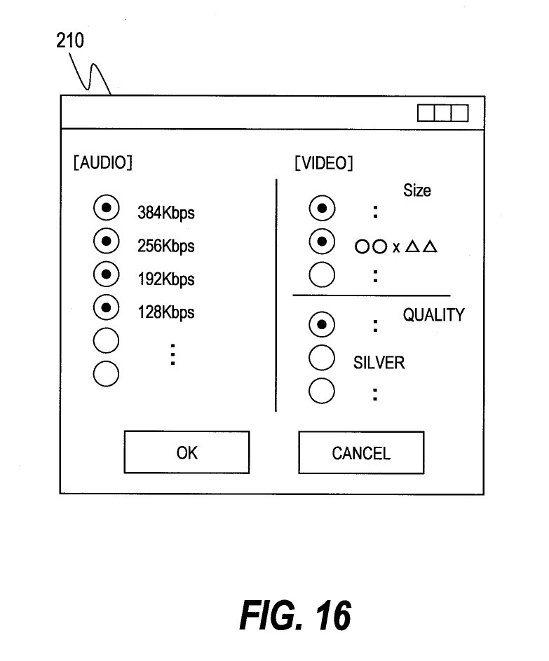

FIG. 16 shows an example of a screen 210 for presetting an alternative proposal allowed by the calling side user equipment in accordance with this embodiment of this invention.

The user is required to specify an allowable level or quality level for each medium type such as “Audio”, “Video”, or the like for this presetting of an alternative proposal. On the setting screen 210, the user selects information of an allowable medium with use of a check box. On the setting screen 210, besides the items shown in FIG. 16, other items such as flow directions (two way/sending direction/receiving direction), etc. may be added.

Although the user is required to select a value denoting a target band on the setting screen 210, the screen 210 may enable the user to specify a codec type such as “PCMU”, “G.729”, or the like. In case where the user specify a codec type, the user is notified of a codec type as an alternative proposal, so that the user can make a comparison among presented proposals. If the user is required to select a target band with a value, the user equipment is required to include such a conversion table as a media mapping table. Thus in case where the user sends/receives a message including a codec type like such a session control protocol as the SIP, the codec type itself can be set additionally on the screen 210. As a result, the conversion table is not required, thereby the conversion processing load can be eliminated.

In accordance with this embodiment of this invention, the session control unit 1 issues QoS requests to the QoS control unit 2. However, another unit may issue such QoS requests. For example, any of an application server, a network monitoring unit for monitoring the traffic state of a network, and a network management unit for controlling the network configuration or the communication path may issue such QoS requests. The QoS request issuing timing depends on the specifications of each of those units.

The configuration of the QoS control unit 2 and the QoS request parameters are the same as those of a case in which QoS requests are issued from the session control unit 1. The processing procedures of the QoS control unit 2 are also the same as those of the flowchart shown in FIG. 10. In addition, the sequences for exchanging messages between the unit for issuing QoS requests and the QoS control unit 2 are the same as S74 of the QoS and as S76 of the result response shown in FIG. 12.

According to an embodiment of this invention, the QoS control unit determines whether or not it is possible to supply a requested resource and requested quality and selects an alternative proposal if it is impossible to supply the requested quality. Then, the session control unit converts the presented alternative proposal and presents the converted proposal to the request source as medium information. Consequently, each of the user and the application that request a session connection can determine whether or not the presented alternative proposal can be used for the session re-connection, since an acceptable alternative proposal is presented if the request is not accepted. Furthermore, because the user is not required to repeat the re-connection while repeating the re-connection by trial and error with the allowable alternative proposal, the convenience can be improved and the traffic can be reduced.

While the present invention has been described in detail and pictorially in the accompanying drawings, the present invention is not limited to such detail but covers various obvious modifications and equivalent arrangements, which fall within the purview of the appended claims.

What is claimed is:

1. A QoS control system for controlling allocation of a resource in a network, comprising:
a terminal unit;
a node unit for transferring a packet which is sent and to be received by the terminal unit;
a resource requesting unit for requesting to allocate a resource of the node unit; and
a QoS control unit for controlling allocation of a resource of the node unit;
wherein the QoS control unit manages communication path information for transferring the packet received by the node unit, and resource information of the node unit;
wherein the QoS control unit determines whether or not a node unit included in the communication path through which the terminal unit makes a communication can provide with a resource requested from the resource requesting unit; and
wherein the QoS control unit determines an alternative proposal of the requested resource when the node unit cannot provide with the requested resource, and notifies the resource requesting unit of the alternative proposal.

2. The QoS control system according to claim 1, wherein the QoS control unit notifies a band which can be provided with as the alternative proposal when the resource requesting unit cannot provide with the requested resource.

3. The QoS control system according to claim 1, wherein the QoS control unit notifies one of a plurality of output queues provided for the node unit as the alternative proposal when the node unit cannot provide with the resource requested by he resource requesting unit, the notified output queue having a priority level different from a requested priority level.

4. The QoS control system according to claim 1, wherein the QoS control unit notifies a time on which the requested resource can be provided with as the alternative proposal when the node unit cannot provide with the resource requested by he resource requesting unit upon receiving request.

5. The QoS control system according to claim 1,
wherein the resource requesting unit is a session control unit for transferring a call control message which is sent and to be received by the terminal unit;
wherein the session control unit determines a resource requested to the node unit according to medium information included in the call control message sent from the terminal unit; and
wherein, upon receiving a response that includes an alternative proposal from the QoS control unit, the session control unit converts resource information of the alternative proposal to medium information includable in the call control message, and transfers the call control message including the converted medium information to the terminal unit.

6. The QoS control system according to claim 5, wherein the session control unit requests the QoS control unit to allocate a resource of the node unit upon receiving a response to a connection request in a negotiation procedure between the terminal unit with using a call control message.

7. A QoS control unit included in a QoS control system for controlling allocation of a resource in a network;
wherein the QoS control unit controls allocation of a resource of a node unit that transfers a packet which is sent and to be received by a terminal unit and is connected to a resource requesting unit that requests to allocate a resource through the network;
wherein the QoS control unit manages communication path information for transferring the packet received by the node unit, and resource information of the node unit;
wherein the QoS control unit determines whether or not a node unit included in the communication path through which the terminal unit makes a communication can provide with a resource requested from the resource requesting unit; and
wherein, the QoS control unit determines an alternative proposal of the requested resource when the node unit cannot provide with the requested resource, and notifies the resource requesting unit of the alternative proposal.

8. The QoS control unit according to claim 7, wherein the QoS control unit notifies a band which can be provided with as the alternative proposal when the node unit cannot provide with the requested resource.

9. The QoS control unit according to claim 7, wherein the QoS control unit notifies one of a plurality of output queues provided in the node unit as the alternative proposal when the node unit cannot provide with the resource requested by he resource requesting unit, the notified output queue having a priority level different from the requested priority level.

10. The QoS control system according to claim 7, wherein the QoS control unit notifies a time on which the requested resource can be provided with as the alternative proposal when the node unit cannot provide with the resource requested by he resource requesting unit upon receiving request.

11. A session control unit included in a QoS control system for controlling allocation of a resource in a network,
wherein the session control unit is connected to a QoS control unit for controlling allocation of a resource of a node unit that transfers a packet sent/received by a terminal unit;
wherein the session control unit transfers a call control message which is sent and to be received by the terminal unit;
wherein the session control unit determines a resource requested to the node unit according to medium information included in the call control message sent from the terminal unit; and
wherein, upon receiving a response that includes an alternative proposal from the QoS control unit, the session control unit converts the resource information of the alternative proposal to medium information included in the call control message, and transfers the call control message including the converted medium information to the terminal unit.

12. The session control unit according to claim 11, wherein the session control unit requests the QoS control unit to allocate a resource of the node unit upon receiving a response to a connection request in a negotiation procedure of the terminal unit with using the call control message.
